(19) United States
(12) Patent Application Publication
(10) Pub. No.: US 2013/0074815 A1
(43) Pub. Date: Mar. 28, 2013

(54) BLOW-BY GAS TREATMENT DEVICE FOR ENGINE

(71) Applicants: Yusuke Yuge, Hamamatsu-Shi (JP); Hiroki Nagaya, Hamamatsu-Shi (JP)

(72) Inventors: Yusuke Yuge, Hamamatsu-Shi (JP); Hiroki Nagaya, Hamamatsu-Shi (JP)

(73) Assignee: SUZUKI MOTOR CORPORATION, Shizuoka-Ken (JP)

(21) Appl. No.: 13/697,564

(22) PCT Filed: May 13, 2011
(86) PCT No.: PCT/JP2011/061056

§ 371 Date: Dec. 12, 2012

(30) Foreign Application Priority Data
May 18, 2010 (JP) 2010-114407

(51) Int. Cl. F02B 47/04

(52) U.S. Cl. CPC F02B 47/04
USPC 123/574

(57) ABSTRACT

A blow-by gas treatment device for an engine configured such that the upper end of a portion of a passage for introducing fresh air and discharging blow-by gas vertically faces an opening section, the portion being located further toward the crank chamber side than a first breather chamber, and also such that a communication section communicating with the space within a variable valve chamber is provided between the upper end and the opening section. The area of the communication of the communication section is set so that the amount of increase in the pressure within the variable valve chamber relative to the pressure within the first breather chamber does not exceed a predetermined value when blow-by gas flows to the air intake passage not only from a passage dedicated for discharging blow-by gas but also from the passage for introducing fresh air and discharging blow-by gas.

### PRIORITY CLAIM

This patent application is a U.S. National Phase of International Patent Application No. PCT/JP2011/061056, filed 13 May 2011, which claims priority to Japanese Patent Application No. 2010-114407, filed 18 May 2010, the disclosures of which are incorporated herein by reference in their entirety.

### TECHNICAL FIELD

The present invention relates to a blow-by gas treatment device for an engine, and more particularly, to a blow-by gas treatment device for an engine, capable of performing sufficient gas exchange between fresh air and a blow-by gas in a crank chamber of the engine.

### BACKGROUND ART

FIG. 6 illustrates a diagram showing a schematic outline structure of a prior-art engine 101, and in the engine 101, respective components or parts are disposed or arranged such that: a cylinder head 103 is attached to an upper portion of a cylinder block 102; an intake cam shaft 104 and an exhaust cam shaft 105 are pivotally supported on the cylinder head 103; a head cover 106 is attached to the cylinder head 103 so as to form a valve train chamber 107 inside the head cover 106; and a crank shaft 108 is pivotally supported on a lower portion of the cylinder block 102, to which an oil pan 109 is mounted, thus forming a crank chamber 110 inside the engine 101. Further, the engine 101 is provided with a throttle valve 114 in an intake passage 113 leading from an air cleaner 111 to a combustion chamber 112.

The engine is further provided with a blow-by gas treatment device. In a blow-by gas treatment device 115 of the prior-art engine 101 illustrated in FIG. 6, a first breather chamber 117 and a second breather chamber 118 divided by a breather plate 116 are arranged above the valve train chamber 107. Furthermore, an upstream side of the throttle valve 114 in the intake passage 113 is connected to the first breather chamber 117 by a first breather pipe 119, and the first breather chamber 117 is connected to the crank chamber 110 by a first through hole 120 penetrating the cylinder head 103 and the cylinder block 102.

According to the arrangement and structure mentioned above, the upstream side of the throttle valve 114 in the intake passage 113 and the crank chamber 110 are communicated with each other by a fresh-air introduction and blow-by gas discharge passage 121 passing through the first breather chamber 117 and the valve train chamber 107.

Moreover, in the blow-by gas treatment device 115, a downstream side of the throttle valve 114 in the intake passage 113 and the second breather chamber 118 are connected by a second breather pipe 122, and in addition, the second breather chamber 118 and the crank chamber 110 are connected by a second through hole 123 penetrating the cylinder head 103 and the cylinder block 102.

According to such arrangement or structure as mentioned above, the downstream side of the throttle valve 114 of the intake passage 113 and the crank chamber 110 are communicated with each other by a blow-by gas discharge exclusive passage 124 passing through the second breather chamber 118 and the valve train chamber 107.

Further, a PCV valve 125 for adjusting a flow rate of the blow-by gas in accordance with a negative pressure in the intake passage 113 is arranged on an upstream end of the second breather pipe 122 on the downstream side of the second breather chamber 118 in the blow-by gas discharge exclusive passage 124.

The blow-by gas treatment device 115 is provided with an opening portion 126 for fresh air and a blow-by gas in the breather plate 116, which constitutes a bottom surface of the first breather chamber 117, and also provided with an oil return hole 127 for returning oil separated from the blow-by gas to the valve train chamber 107. Moreover, the breather plate 116, which constitutes a bottom surface of the second breather chamber 118, is provided with an inlet portion 128 for a blow-by gas, and also provided with an oil return hole 129 for returning the oil separated from the blow-by gas to the valve train chamber 107.

In the blow-by gas treatment device 115 of the engine 101, if the upper end portion of the fresh-air introduction and blow-by gas discharge passage 121 in the valve train chamber 107 is directly communicated with the opening portion 126 of the first breather chamber 117, a large quantity of fresh air can be introduced into the crank chamber 110, sufficient gas exchange can be performed between the fresh air and the blow-by gas in the crank chamber 110, and treatment performance for the blow-by gas can be improved.

Moreover, in the prior-art blow-by gas treatment device for an engine, as described in Patent Document 1, for example, either one of the blow-by gas discharge exclusive passage and the fresh-air introduction and blow-by gas discharge exclusive passage (the blow-by gas discharge exclusive passage in an embodiment) is made to communicate directly with the crank chamber and the intake passage without going through the breather chamber.

Furthermore, in the prior-art blow-by gas treatment device for an engine, as described in Patent Document 2, for example, a PCV valve is arranged in the blow-by gas discharge exclusive passage, and a flow control valve for increasing/ decreasing a passage cross section in accordance with an intake passage negative pressure on the throttle valve downstream side is arranged in the fresh-air introduction and blow-by gas discharge passage.

### PRIOR ART DOCUMENT

### Patent Document

[Patent Document 1] Japanese Utility Model Laid-Open Publication No. 58-178404

[Patent Document 2] Japanese Utility Model Laid-Open Publication No. 5-87211

### DISCLOSURE OF THE INVENTION

### Problems to be solved by The Invention

In the prior-art blow-by gas treatment device 115 for the engine 101 having the structure or arrangement described above and illustrated in FIG. 6, if the engine 101 is operated at a low-rotation and with a low-to-medium load, fresh air is introduced into the crank chamber 110 from the fresh-air introduction and blow-by gas discharge passage 121, and the and the blow-by gas in the crank chamber 110 by the blow-by gas discharge exclusive passage 124 is discharged into the intake passage 113 as illustrated in FIG. 7.

Furthermore, in the blow-by gas treatment device 115, as illustrated in FIGS. 8 and 9, if the engine 101 is operated in a high-rotation and with a high load, the blow-by gas in the crank chamber 110 is discharged from both the blow-by gas discharge exclusive passage 124 and the fresh-air introduction and blow-by gas discharge passage 121 into the intake passage 113.

In such case, however, if a blow-by gas generation amount of the engine 101 increases, and if the blow-by gas is discharged into the intake passage 113 from both the blow-by gas discharge exclusive passage 124 and the fresh-air introduction and blow-by gas discharge passage 121, a pressure in the valve train chamber 107 becomes larger than the pressure in the first breather chamber 117, and hence, an oil does not return from the first breather chamber 117 to the valve train chamber 107.

Thus, the oil, which flows with the blow-by gas from the first breather chamber 117 into the intake passage 113 and is lost therein, increases, and as a result, there may cause a fear that the throttle valve 114 and the air cleaner 111 might be stained by the oil.

The present invention has been made in view of the above-described prior-art technologies, and an object of the present invention is to provide a blow-by gas treatment device for an engine capable of improving treatment performance of the blow-by gas, reducing an oil amount lost with the blow-by gas in an operation region where the generation amount of the blow-by gas is large, and preventing on the throttle valve and the air cleaner from being stained by the oil.

### Means for solving The Problems

In order to achieve the above-described object, a blow-by gas treatment device for an engine in a preferred embodiment of the present invention includes: a valve train chamber provided on an upper portion of a cylinder head; a first breather chamber and a second breather chamber provided above the valve train chamber; a crank chamber provided inside a cylinder block; an intake passage leading to a combustion chamber; a throttle valve provided in the intake passage; a fresh-air introduction/blow-by gas discharge passage for communicating an upstream side of the throttle valve in the intake passage and the crank chamber with each other through a passage passing through the first breather chamber and the valve train chamber; a blow-by gas discharge exclusive passage for communicating a downstream side of the throttle valve in the intake passage and the crank chamber with each other through a passage passing through the second breather chamber and the valve train chamber; a PCV valve provided on the downstream side of the second breather chamber in the blow-by gas discharge exclusive passage and configured to adjust a flow rate of a blow-by gas in accordance with a negative pressure in the intake passage; and an opening portion which is formed in a bottom surface of the first breather chamber and through which fresh air and a blow-by gas pass, and an oil return hole for returning oil separated from the blow-by gas to the valve train chamber, wherein an upper end portion of a passage closer to the crank chamber than the first breather chamber in the fresh-air introduction/blow-by gas discharge passage is located so as to oppose to the opening portion in a vertical direction and a communication portion communicating with a space in the valve train chamber is provided between the upper end portion and the opening portion; and wherein when the blow-by gas flows to the intake passage from the fresh-air introduction/blow-by gas discharge passage in addition to the blow-by gas discharge exclusive passage, a communication area of the communicating portion is set so that an increase amount of a pressure in the valve train chamber with respect to the pressure in the first breather chamber is maintained in a range in which the oil returns from the first breather chamber to the valve train chamber.

In the above aspect of the embodiment, it may be desired that the communicating portion has a communication area larger than a passage sectional area of the fresh-air introduction/blow-by gas discharge passage.

Furthermore, it may be also desired that the communicating portion is arranged above a position of the oil return hole in a vertical direction of the engine.

### Effects of The Invention

In the blow-by gas treatment device for the engine in a preferred embodiment of the present invention, if a generated amount of a blow-by gas is small and a negative pressure difference in the intake passage between the upstream and the downstream of the throttle valve is not less than a predetermined value in the engine, fresh air is introduced from the fresh-air introduction/blow-by gas discharge passage to the crank chamber, the blow-by gas is sent to the intake passage from the crank chamber through the blow-by gas discharge exclusive passage by means of gas exchange with the fresh air, and the combustion treatment is then performed. At this time, in the fresh-air introduction/blow-by gas discharge passage, since the upper end portion of the passage closer to the crank chamber side than the first breather chamber is opposed to the opening portion of the first breather camber in the vertical direction, the fresh air can linearly flow from the opening portion of the first breather chamber to the upper end portion of the fresh-air introduction/blow-by gas discharge passage in the valve train chamber and an amount of the fresh air flowing into the crank chamber can be increased. Thus, the blow-by gas treatment device for the engine of the present invention enables sufficient gas exchange between the fresh air and the blow-by gas in the crank chamber, and treatment performance of the blow-by gas can be improved.

Furthermore, in the blow-by gas treatment device for the engine of the present invention, if the generated amount of the blow-by gas is large, the negative pressure difference in the intake passage between the upstream and the downstream of the throttle valve is smaller than the predetermined value, and the blow-by gas is discharged to the intake passage also from the fresh-air introduction/blow-by gas discharge passage in addition to the blow-by gas discharge exclusive passage in the engine, the communication area of the communicating portion is set so that the increase amount of the pressure in the valve train chamber with respect to the pressure in the first breather chamber does not exceed the predetermined value. Thus, according to the blow-by gas treatment device for the engine of the present invention, defective oil return from the first breather chamber to the valve train chamber caused by a pressure rise in the valve train chamber can be prevented, an oil amount lost together with the blow-by gas flowing out of the first breather chamber can be reduced, and stains by the oil on the throttle valve or the air cleaner arranged in the intake passage can be prevented.

Moreover, according to the blow-by gas treatment device for the engine in the present invention, since the fresh-air introduction/blow-by gas discharge passage in which a flow rate of the blow-by gas can be made larger than the blow-by gas discharge exclusive passage provided with the PCV valve is communicated with the inside of the valve train chamber, the pressure in the valve train chamber can be largely lowered as compared with the lowering of the pressure in the valve train chamber by communicating the blowy-by gas discharge exclusive passage with the inside of the valve train chamber.

### BRIEF DESCRIPTION OF THE DRAWINGS

FIG. 1 is an illustrated sectional view of a cylinder head of an engine for showing flows of fresh air, a blow-by gas and oil under a high rotation and a high load operation of the engine according to an embodiment of the present invention.

FIG. 2 is a perspective view of the cylinder head of the engine according to the embodiment of the present invention.

FIG. 3 illustrates an entire configuration of the engine of the embodiment as a sectional view of the engine showing flows of the fresh air, the blow-by gas and the oil under a low rotation and a low-to-medium load operation of the engine.

FIG. 4 illustrates an entire configuration of the engine of the embodiment as a sectional view of the engine showing flows of the fresh air, the blow-by gas and the oil under the high rotation and the high load operation of the engine.

FIG. 5 illustrates a configuration of a breather chamber of the engine of the present embodiment as a sectional view of the breather chamber showing flows of the fresh air, the blow-by gas and the oil under the high rotation and the high load operation of the engine.

FIG. 6 is an illustrated sectional view of an engine in a prior-art example.

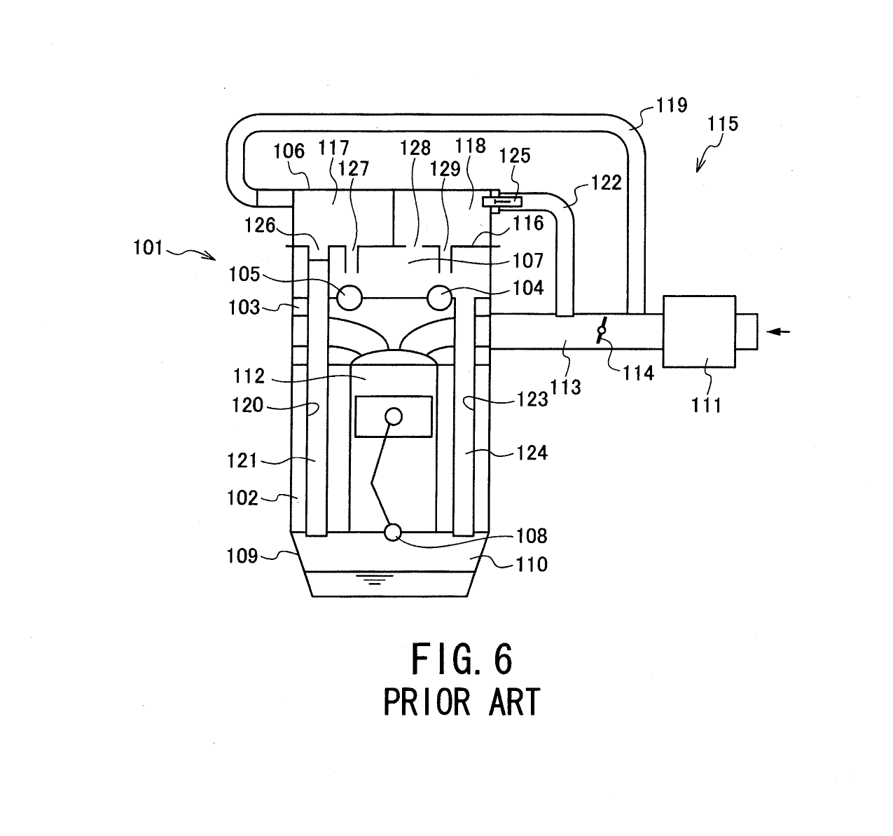

FIG. 7 is an illustrated sectional view of the engine showing flows of the fresh air, the blow-by gas and the oil under a low rotation and a low-to-medium load operation of the engine according to the prior-art example shown in FIG. 6.

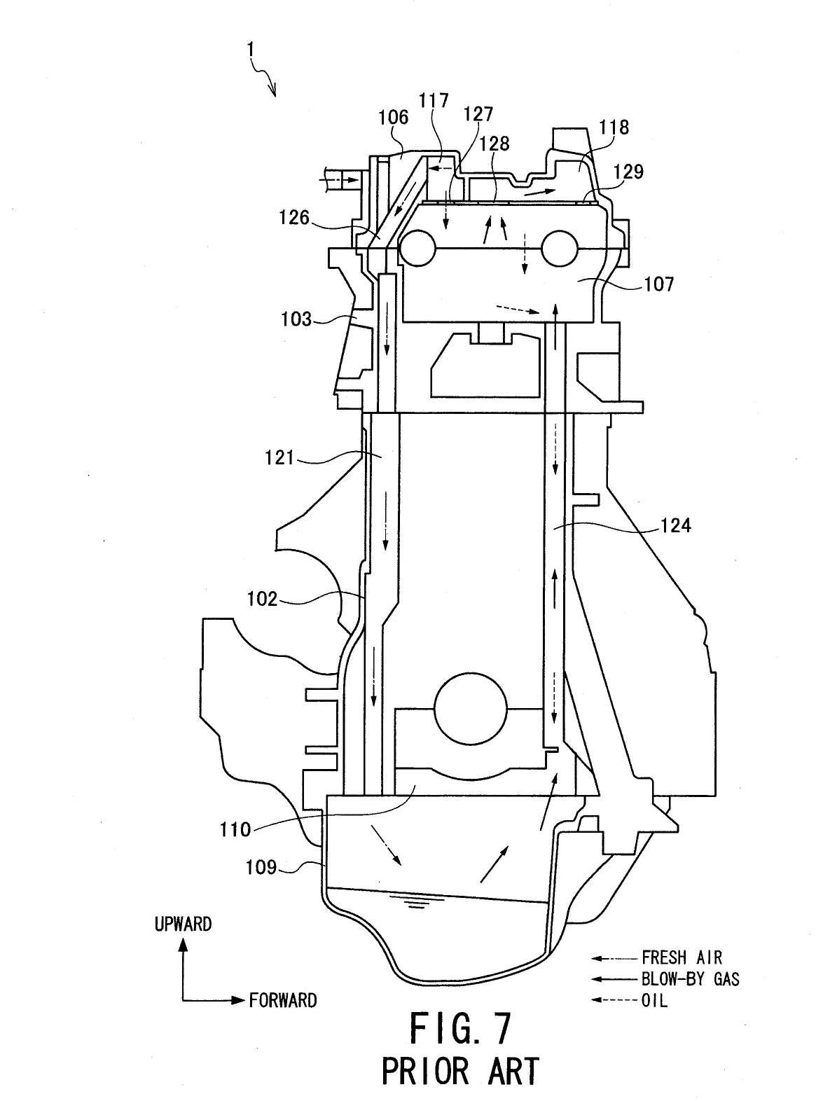

FIG. 8 is an illustrated sectional view of the engine showing flows of the fresh air, the blow-by gas and the oil under a high rotation and a high load operation of the engine of the prior-art example.

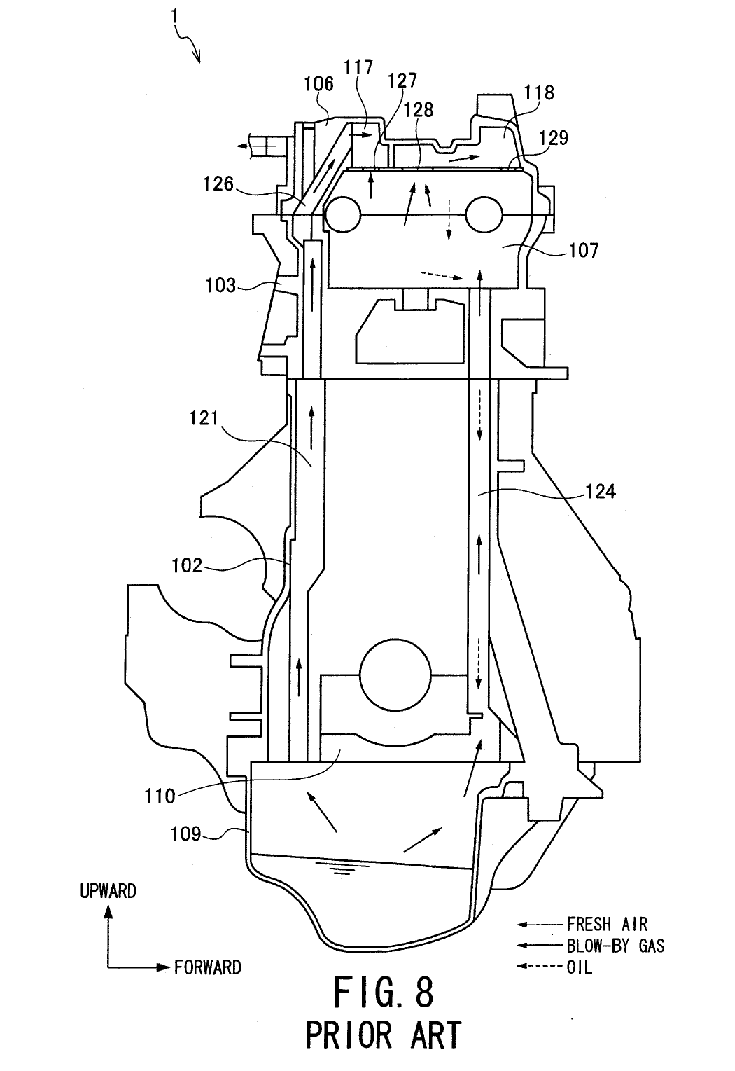

FIG. 9 is an illustrated sectional view of a cylinder head of the engine showing flows of the fresh air, the blow-by gas and the oil under the high rotation and the high load operation of the engine of the prior-art example.

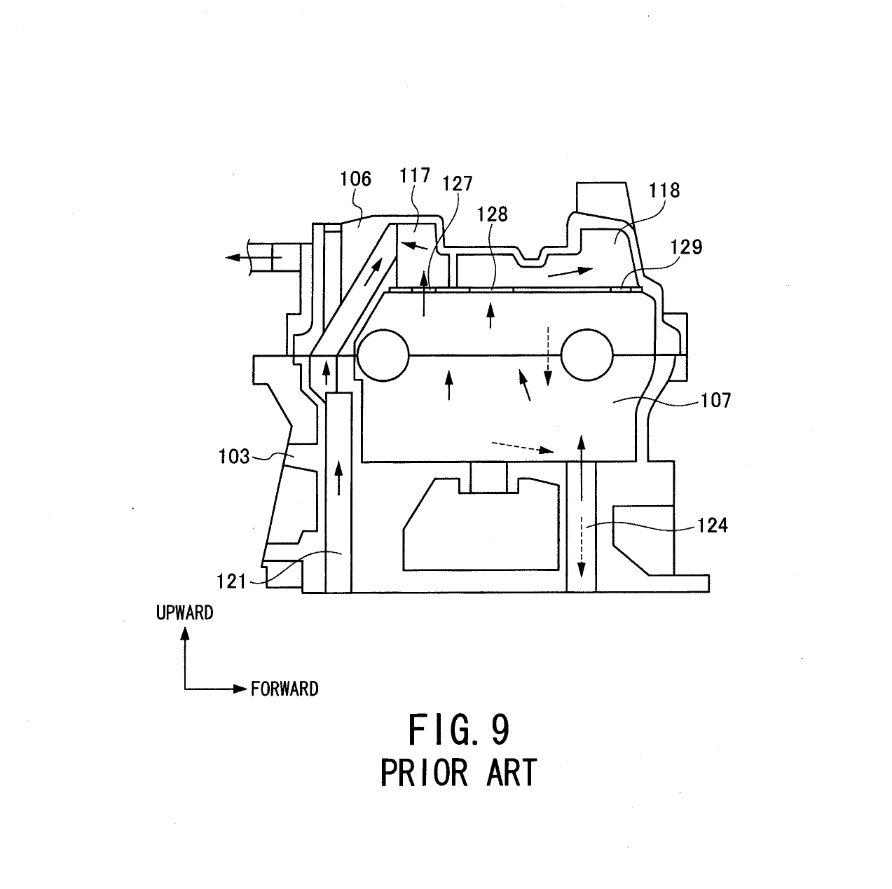

### MODE FOR EMBODYING THE INVENTION

The present invention relates to a blow-by gas treatment device for an engine and provided for the purpose of improving treatment performance of the blow-by gas and reducing an oil amount lost together with the blow-by gas particularly by providing an upper end of a fresh-air introduction and blow-by gas discharge passage so as to oppose to an opening portion of a first breather chamber in a vertical direction and by providing a communicating portion having a predetermined communication area communicating with a space inside a valve train chamber between the upper end portion and this opening portion.

Hereunder, an embodiment of the present invention will be described with reference to the accompanying drawings. In the following description, terms referring to directions (upper and lower, right and left, front and rear, and the like) are used in an illustrated state in the drawings or in an engine in a normal mounted state of an engine.

### EMBODIMENT

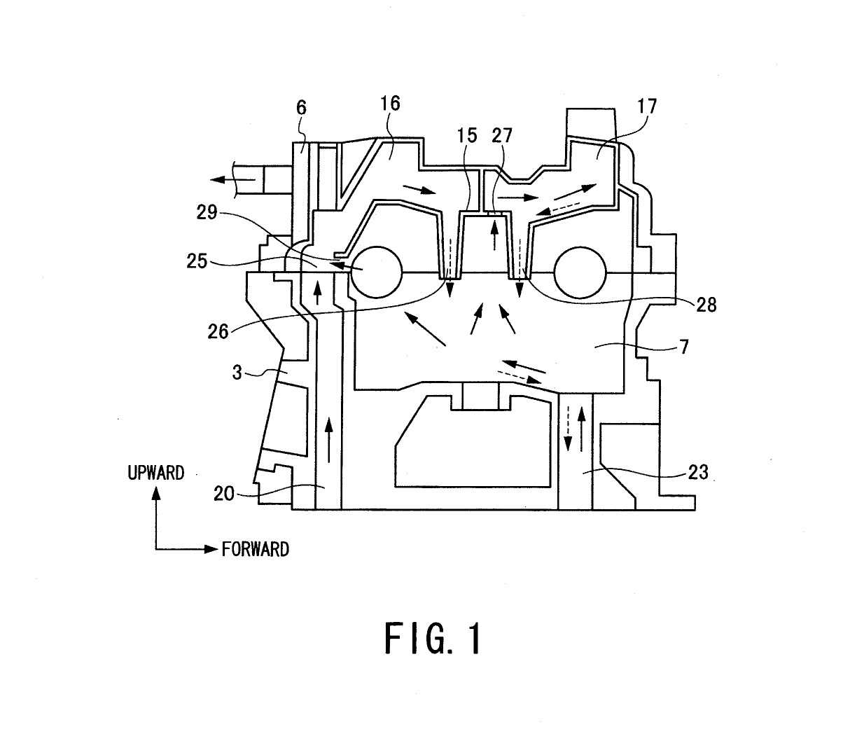

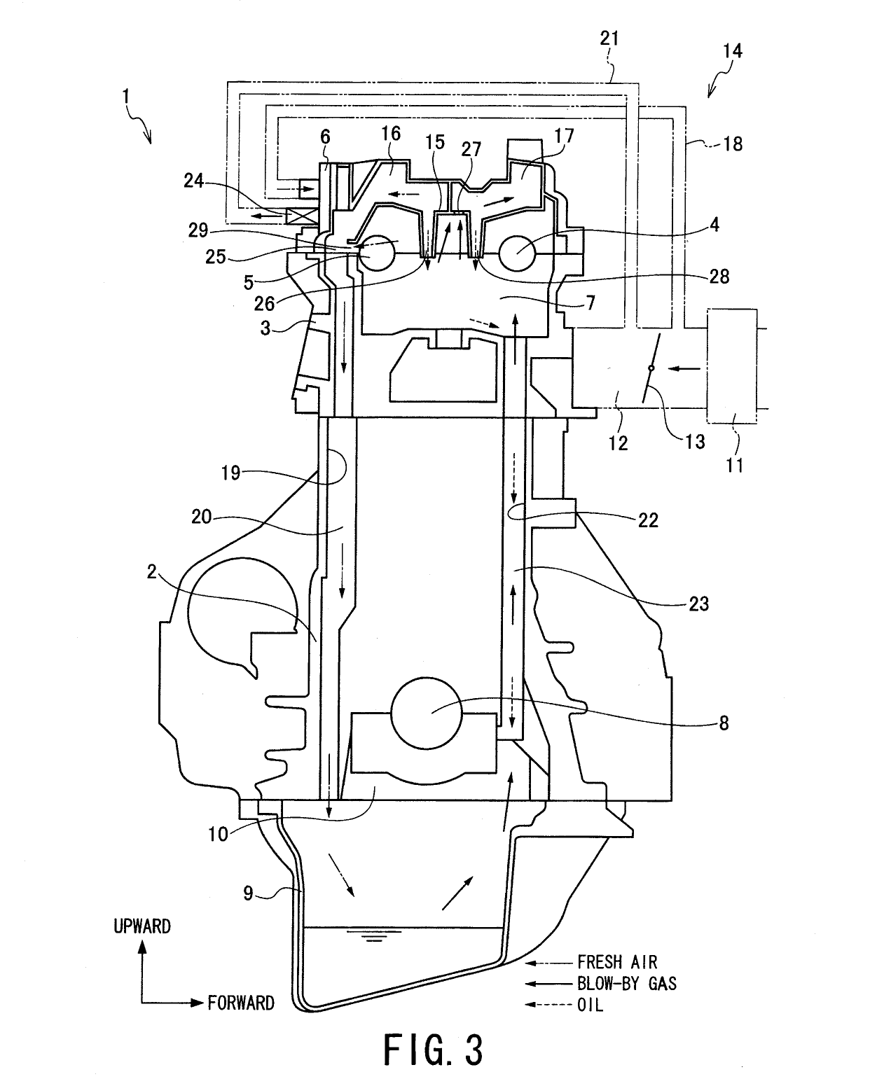

FIGS. 1 to 5 illustrate an embodiment of the present invention. As illustrated in FIG. 3, in an engine 1 (in the present embodiment, an engine to be mounted on a vehicle will be described as a preferred embodiment), a cylinder head 3 is mounted to an upper portion of a cylinder block 2, an intake cam shaft 4 and an exhaust cam shaft 5 are pivotally supported by the cylinder head 3, a head cover 6 is attached to the cylinder head 3, and a valve train chamber 7 is formed on an upper portion of the cylinder head. In addition, an oil pan 9 is attached by pivotally supporting a crank shaft 8 on a lower portion of the cylinder block 3, and a crank chamber 10 is formed inside the cylinder block 3.

The engine 1 is provided with a throttle valve 13 located in an intake passage 12 on the way from an air cleaner 11 to a combustion chamber.

The blow-by gas treatment device 14 for the engine 1 illustrated in FIG. 3 is provided with a first breather chamber 16 and a second breather chamber 17 which are divided by a breather plate 15 arranged above the valve train chamber 7. An upstream side of the throttle valve 13 in the intake passage 12 is connected to the first breather chamber 16 by a first breather pipe 18, and the first breather chamber 16 and the crank chamber 10 are also connected by a first through hole 19 penetrating the cylinder head 3 and the cylinder block 2.

In the blow-by gas treatment device 14, a fresh-air introduction/blow-by gas discharge passage 20 (i.e., passage for introducing fresh air and discharging blow-by gas) is formed by the first breather pipe 18 and the first through hole 19, and the upstream side of the throttle valve 13 in the intake passage 12 and the crank chamber 10 are communicated with each other by the fresh-air introduction/blow-by gas discharge passage 20 passing through the first breather chamber 16 and the valve train chamber 7.

Furthermore, in the blow-by gas treatment device 14, a downstream side of the throttle valve 13 in the intake passage 12 and the second breather chamber 17 are connected by a second breather pipe 21, and the second breather chamber 17 and the crank chamber 10 are also connected by a second through hole 22 penetrating the cylinder head 3 and the cylinder block 2.

In the blow-by gas treatment device 14, a blow-by gas discharge exclusive passage 23 is formed by a second breather pipe 21 and a second through hole 22, and a downstream side of the throttle valve 13 in the intake passage 12 and the crank chamber 10 are made to communicate with each other by the blow-by gas discharge exclusive passage 23 passing through the second breather chamber 17 and the valve train chamber 7.

In addition, a PCV valve 24 for adjusting a flow rate of the blow-by gas in accordance with a negative pressure in the intake passage 12 is arranged at an upstream end of the second breather pipe 21 on the downstream side of the second breather chamber 17 in the blow-by gas discharge exclusive passage 23.

Furthermore, in the blow-by gas treatment device 14, an opening portion 25 for fresh air and the blow-by gas and an oil return hole 26 for returning oil separated from the blow-by gas to the valve train chamber 7 are formed in the breather plate 15 which constitutes a bottom surface of the first breather chamber 16, and an inlet portion 27 for the blow-by gas and an oil return hole 28 for returning the oil separated from the blow-by gas to the valve train chamber 7 are also formed in the breather plate 15 which constitutes the bottom surface of the second breather chamber 17.

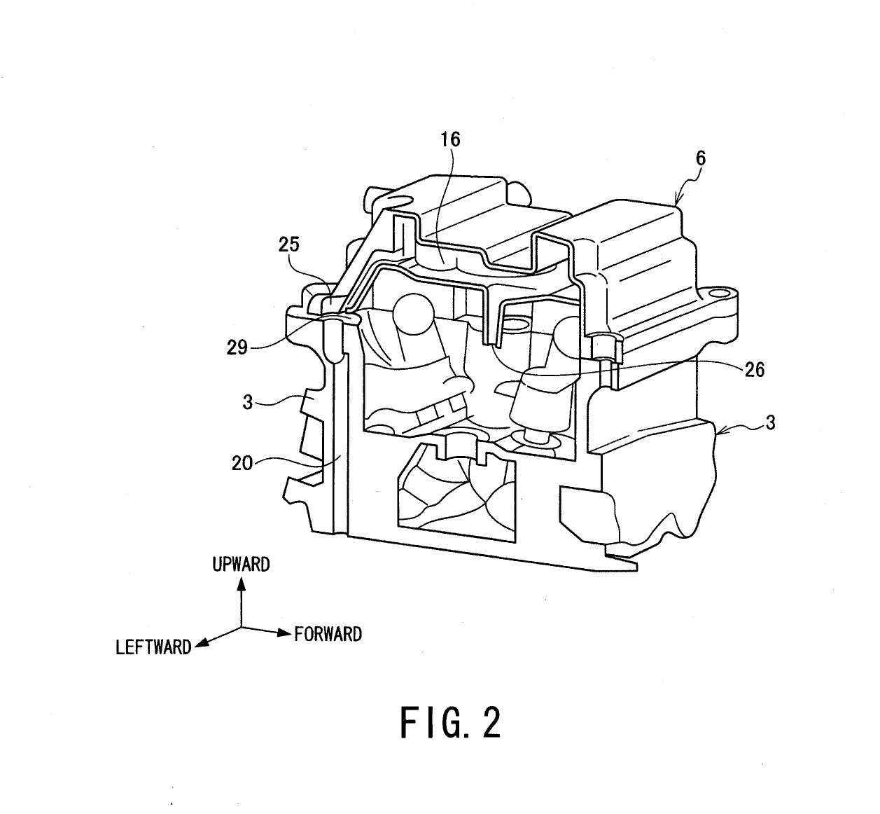

In the blow-by gas treatment device 14 for the engine of the present embodiment, as illustrated in FIGS. 1 and 2, an upper end portion, of the fresh-air introduction/blow-by gas discharge passage 20, closer to the crank chamber 10 side than the first breather chamber 16 in the passage 20 is located so as to oppose to the opening portion 25 in the vertical direction, and a communicating portion 29 communicating with a space in the valve train chamber 7 is provided between the upper end portion and the opening portion 25.

Further, the communication portion 29 has the communication area (cross sectional area) set so that, if the blow-by gas flows into the intake passage 12 also from the fresh-air introduction/blow-by gas discharge passage 20 in addition to the blow-by gas discharge exclusive passage 23, an increase amount of a pressure in the valve train chamber 7 with respect to the pressure in the first breather chamber 16 does not exceed a predetermined value, that is, in other words, so that the increase amount of the pressure in the valve train chamber 7 with respect to the pressure in the first breather chamber 16 can be maintained within a range in which the oil can return from the first breather chamber 16 to the valve train chamber 7.

In addition, the communication are of the communicating portion 29 is set larger than a passage cross-sectional area of the fresh-air introduction/blow-by gas discharge passage 20. Further, the communication portion 29 is arranged above the location of the oil return hole 26 of the first breather chamber 16 in the vertical direction of the engine.

In the following, operation and action or function of the blow-by gas treatment device 14 for the engine 1 according to the present embodiment will be described.

In the blow-by gas treatment device 14 for the engine 1 of the present embodiment, as illustrated in FIG. 3, in a case where the engine 1 is operated in a low rotation and with a low-to-medium load, a small amount of the blow-by gas is generated, and a negative pressure difference in the intake passage between the upstream and the downstream of the throttle valve is not less than a predetermined value, fresh air is introduced from the fresh-air introduction/blow-by gas discharge passage 20 to the crank chamber 10, the blow-by gas is then sent to the intake passage 12 from the crank chamber 10 through the blow-by gas discharge exclusive passage 23 by gas exchange with the fresh air, and the combustion treatment is performed.

In such case as mentioned above, in the blow-by gas treatment device 14, the upper end portion of the passage closer to the crank chamber 10 side than the first breather chamber 16 in the fresh-air introduction and blow-by gas discharge passage 20 is opposed to the opening portion 25 of the first breather chamber 16 in the vertical direction, and accordingly, the fresh air can be made to linearly flow from the opening portion 25 of the first breather chamber 16 to the upper end portion of the fresh-air introduction/blow-by gas discharge passage 20 in the valve train chamber 7, and hence, an amount of the fresh air flowing into the crank chamber 10 can be increased.

Thus, according to the blow-by gas treatment device 14 for the engine 1 of the present embodiment, the sufficient gas exchange between the fresh air and the blow-by gas can be surely performed in the crank chamber 10, and the treatment performance of the blow-by gas can be improved.

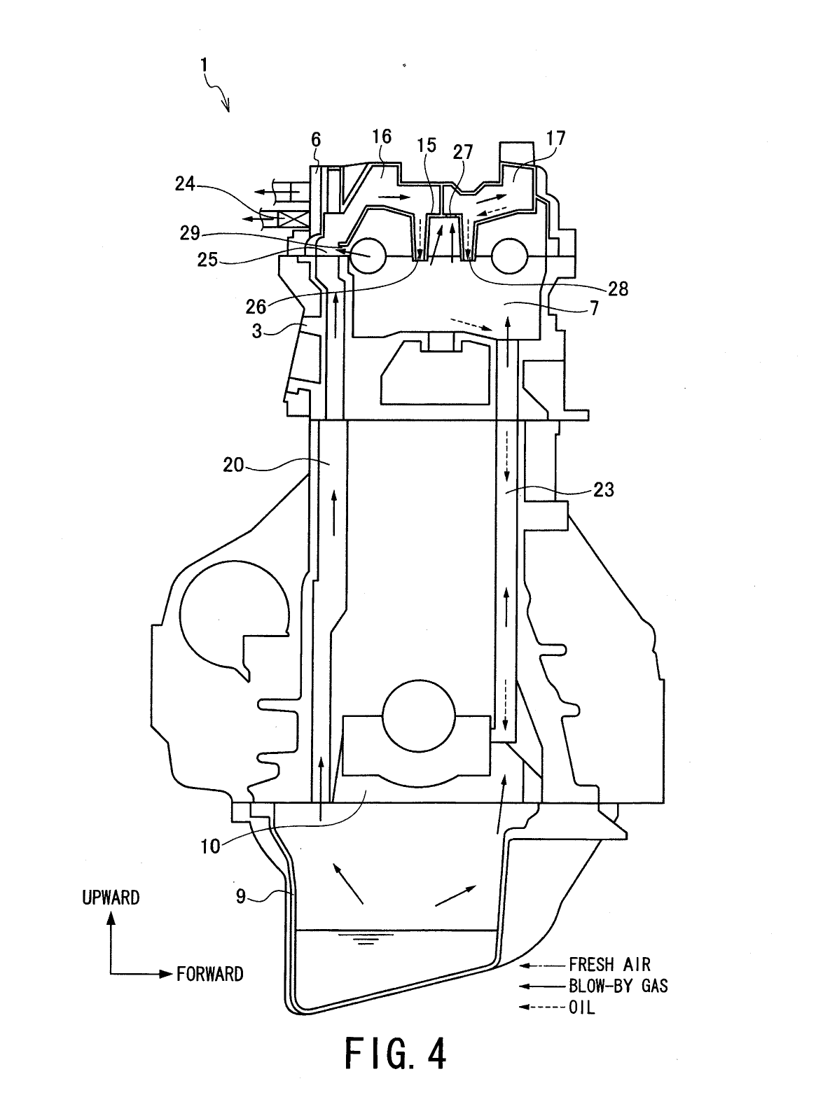

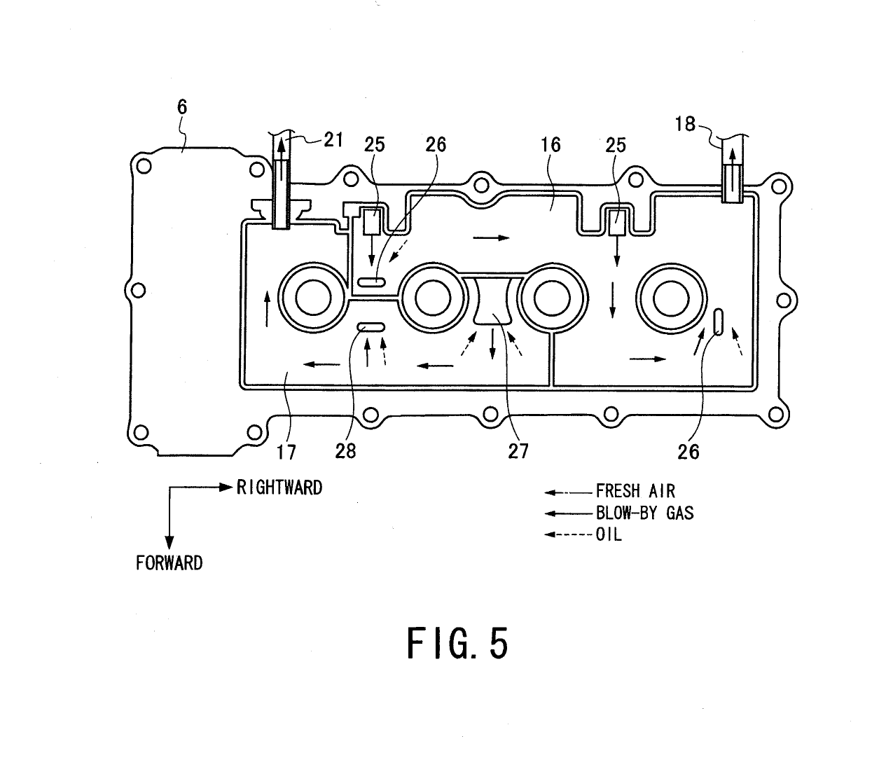

Furthermore, according to the blow-by gas treatment device 14 for the engine 1 of the present embodiment, as illustrated in FIGS. 4 and 5, the communication area of the communicating portion 29 is set so that, if the engine 1 is operated in a high rotation and with a high load, the large amount of the blow-by gas is generated, and the negative pressure difference in the intake passage 12 between the upstream and the downstream of the throttle valve 13 becomes smaller than the predetermined value, and the blow-by gas is discharged to the intake passage 12 also from the fresh-air introduction/blow-by gas discharge passage 20 in addition to the blow-by gas discharge exclusive passage 23, the increase amount of the pressure in the valve train chamber 7 with respect to the pressure in the first breather chamber 16 does not exceed the predetermined value.

Thus, according to the blow-by gas treatment device 14, defective oil return (backflow of oil in the oil return hole 26) from the first breather chamber 16 to the valve train chamber 7 caused by a pressure rise in the valve train chamber 7 can be prevented. In addition, an oil amount lost together with the blow-by gas flowing out of the first breather chamber 16 can be reduced, and the throttle valve 13 and the air cleaner 11 arranged in the intake passage 12 can be prevented from being stained by the oil.

Furthermore, in the blow-by gas treatment device 14 for the engine 1 of the described embodiment, since the fresh-air introduction/blow-by gas discharge passage 20, in which a flow rate of the blow-by gas can be made larger than the blow-by gas discharge exclusive passage 23 provided with the PCV valve 24, is communicated with the inside of the valve train chamber 7 through the communicating portion 29, the pressure in the valve train chamber 7 can be much lowered as compared with the lowering of the pressure in the valve train chamber 7 by making communicate the blow-by gas discharge exclusive passage 23 communicate with the inside of the valve train chamber 7.

Still furthermore, the communication area of the communicating portion 29 with respect to the valve train chamber 7 is set larger than the passage cross-sectional area of the fresh-air introduction/blow-by gas discharge passage 20, and accordingly, the blow-by gas flowing into the valve train chamber 7 can flow into the fresh-air introduction/blow-by gas discharge passage 20 with a large quantity, and in addition, the increase amount of the pressure in the valve train chamber 7 with respect to the pressure in the first breather chamber 16 can be maintained so as not to exceed the predetermined value.

Still furthermore, since the communicating portion 29 is arranged above the position of the oil return hole 26 in the vertical direction, the oil dropping from the oil return hole 26 is prevented from being sucked again into the communicating portion 29.

It is further to be noted that, in the above-described embodiment, although the blow-by gas treatment device for the engine to be mounted on a vehicle is described, the present invention is not limited to such embodiment and is applicable to any type of engine as far as it makes possible to improve the performance and reduce an oil amount lost together with the blow-by gas.

### INDUSTRIAL APPLICABILITY

The present invention improves treatment performance of the blow-by gas of an engine and reduces an oil amount lost together with the blow-by gas, and hence, is applicable not only to an engine to be mounted on a vehicle but also to any type of engine.

### REFERENCE NUMERALS

1—engine
2—cylinder block
3—cylinder head
6—head cover
7—valve train chamber
9—oil pan
10—crank chamber
12—intake passage
13—throttle valve
14—blow-by gas treatment device
16—first breather chamber
17—second breather chamber
20—fresh-air introduction/blow-by gas discharge passage
23—blow-by gas discharge exclusive passage
24—PCV valve
25—opening portion
26—oil return hole
27—inlet port
28—oil return hole
29—communicating portion

1. A blow-by gas treatment device for an engine comprising:
a valve train chamber provided on an upper portion of a cylinder head;
a first breather chamber and a second breather chamber provided above the valve train chamber;
a crank chamber provided inside a cylinder block;
an intake passage leading to a combustion chamber;
a throttle valve provided in the intake passage;
a fresh-air introduction/blow-by gas discharge passage for communicating an upstream side of the throttle valve in the intake passage and the crank chamber with each other through a passage passing through the first breather chamber and the valve train chamber;
a blow-by gas discharge exclusive passage for communicating a downstream side of the throttle valve in the intake passage and the crank chamber with each other through a passage passing through the second breather chamber and the valve train chamber;
a PCV valve provided on the downstream side of the second breather chamber in the blow-by gas discharge exclusive passage and configured to adjust a flow rate of a blow-by gas in accordance with a negative pressure in the intake passage; and
an opening portion which is formed in a bottom surface of the first breather chamber and through which fresh air and a blow-by gas pass, and an oil return hole for returning oil separated from the blow-by gas to the valve train chamber,
wherein an upper end portion of a passage closer to the crank chamber than the first breather chamber in the fresh-air introduction/blow-by gas discharge passage is located so as to oppose to the opening portion in a vertical direction and a communication portion communicating with a space in the valve train chamber is provided between the upper end portion and the opening portion; and
wherein when the blow-by gas flows to the intake passage from the fresh-air introduction/blow-by gas discharge passage in addition to the blow-by gas discharge exclusive passage, a communication area of the communicating portion is set so that an increase amount of a pressure in the valve train chamber with respect to the pressure in the first breather chamber is maintained in a range in which the oil returns from the first breather chamber to the valve train chamber.

2. The blow-by gas treatment device for an engine according to claim 1, wherein the communicating portion has a communication area larger than a passage sectional area of the fresh-air introduction/blow-by gas discharge passage.

3. The blow-by gas treatment device for an engine according to claim 1, wherein the communicating portion is arranged above a position of the oil return hole in a vertical direction of the engine.
